(19) United States
(12) Patent Application Publication
(10) Pub. No.: US 2008/0001526 A1
(43) Pub. Date: Jan. 3, 2008

(54) Method for Fabricating Light-Emitting Display, Method for Manufacturing Led Unit, Structure of Connection Block Having Led Unit

(75) Inventor: Yukihiro Murakami, Minato-ku (JP)

Correspondence Address: OLIFF & BERRIDGE, PLC, P.O. BOX 320850, ALEXANDRIA, VA, 22320-4850, US

(73) Assignee: INTELLECTUAL PROPERTY BANK CORP., Tokyo (JP)

(21) Appl. No.: 11/662,369

(22) PCT Filed: Sep. 21, 2005
(86) PCT No.: PCT/JP05/17365

§ 371 Date: Mar. 8, 2007

(30) Foreign Application Priority Data
Sep. 22, 2004 (JP) 2004-274650

(51) Int. Cl. H01J 1/62; G08B 5/22; H01J 9/00; H01J 9/24; H05B 33/00

(52) U.S. Cl. 313/500; 340/815.45; 445/24

(57) ABSTRACT

A method of fabricating a display and re-fabricating a disassembled display, by arbitrarily combining light-emitting units. Connection blocks are used in the method. Three generally flat metallic conductors spaced apart are mechanically interconnected using an insulating resin, outer one of the three generally flat metallic conductors is made a positive electrode element, the other outer one is made a negative electrode element, and the middle one is made a relay element. A predetermined region of each end of the metallic conductors except the intermediate conductor is exposed for use as an extension electrode. A chip LED is laser-welded between the positive electrode element and the relay element and a chip resistor is laser-welded between the relay element and the negative electrode element to form a light-emitting unit. Electrodes between multiple light-emitting units are electrically connected in a detachable manner by means of multiple connection blocks to fabricate a display.

### TECHNICAL FIELD

The present invention relates to a method for detachably fabricating a display in any shape using multiple LED units, wherein the LED units are detachably combined, and to an LED unit and a connection block structure for implementing the method.

To achieve the object, the present invention provides a method for fabricating a light-emitting unit, including the steps of: mechanically interconnecting three generally flat metallic conductors spaced apart by using an insulating resin; making outer one of the three generally flat metallic conductors a positive electrode element; making the other outer one of the three generally flat metallic conductors a negative electrode element; making the middle one of the three generally flat metallic conductors an intermediate element; exposing a predetermined region of each end of the metallic conductors except for the intermediate conductor as an extension electrode; and laser-welding a chip LED between the positive electrode and intermediate elements. The present invention also provides a display in any shape fabricated by detachably and electrically interconnecting electrodes of multiple light-emitting units fabricated by these steps by means of connection blocks.

Another object is to provide a method for fabricating a three-dimensional display by three-dimensionally combining LED units in a detachable manner.

### BACKGROUND ART

There have been methods for fabricating a display using LEDs as light emitters, such as a method in which a printed-wiring board is designed in accordance with a pattern beforehand and then LED light emitters and resistors are mounted on it, a method in which LEDs are disposed in accordance with a pattern beforehand and then leads of the LEDs, resistors, and wires are directly connected and soldered, a method in which LEDs are laid out in accordance with a pattern beforehand and then the leads of the LEDs, resistors, and wires are sleeve-joined, and a method in which LEDs are disposed in accordance with a pattern beforehand and then the LEDs, resistors, and wires are entwined with a bus bar and clamped.

Patent Document 1 describes a method in which LEDs are mounted on an elongated patterned flexible conductor vertically to the length of the conductor to form a combined LED light emitter array and then required portions are cut from the array in accordance with a design to construct a light-emitting display.

Patent Document 2 describes an example in which an LED unit including a power-supply connecting terminal of predetermined size, a power-supply extension terminal, an LED, and a current-limiting resistor is inserted in a board having power-supply pins evenly spaced apart, thereby detachably fabricating a display.

None of these conventional-art methods are capable of flexibly combining LED unit linearly, two-dimensionally, or three-dimensionally in a detachable manner to form a light-emitting display.

Patent Document 1: WO2002/089222

Patent Document 2: U.S. Pat. No. 6,443,796

### DISCLOSURE OF THE INVENTION

### Problems to be Solved by the Invention

The conventional methods for combining LED units into a pattern requires that the arrangement of colors be determined and provided beforehand in addition to designing a printed-circuit board in accordance with a pattern.

Patent Document 1 describes a method in which LEDs are mounted on an elongated patterned flexible conductor vertically to the length of the conductor to form a combined LED light emitter array and required portions are cut from the array in accordance with a design to fabricate a light-emitting display. However, this method has limited flexibility of fabrication because it does not allow the design to be modified once the LED display has been fabricated and, in addition, requires that the arrangement of colors of the LEDs be determined before the LEDs are mounted on the long conductor.

Patent Document 2 describes an example in which an LED unit including a power-supply connecting terminal of predetermined size, a power-supply extension terminal, an LED, and current-limiting resistor is inserted in a board having power-supply pins evenly spaced apart, thereby detachably fabricating a display. However, since the method requires a board including multiple power-supply pins evenly spaced apart, the method cannot be applied to patterns that use boards of different sizes, and requires a large number of LED units for fabricating a three-dimensional display.

That is, it has been difficult to combine multiple LED units to refabricate a combined light emitter array in such a manner that light emitters can be flexibly attached and detached.

First, there is a problem caused by power supply. For an LED to emit light, several volts of direct-current power supply are required, and this must be supplied in some way. However, the conventional methods lack that scalability.

A second problem is that LEDs is that, because they are vulnerable to heat generated by an excess current, the brightness gradually decreases during use and their life is shortened by the heat. Therefore, LEDs require current-limiting resistors. However, the method in which LED units are connected in series has a problem that the brightness of LEDs forming an array of combined light emitters decreases if a current-limiting resistor having a single resistance value is contained in an LED unit. This problem restricts the configuration of a display formed by combining LED units.

### Means for Solving Problem

To achieve the object, the present invention provides a method for fabricating a light-emitting unit, including the steps of: mechanically interconnecting three generally flat metallic conductors spaced apart by using an insulating resin; making outer one of the three generally flat metallic conductors a positive electrode element; making the other outer one of the three generally flat metallic conductors a negative electrode element; making the middle one of the three generally flat metallic conductors an intermediate element; exposing a predetermined region of each end of the metallic conductors except for the intermediate conductor as an extension electrode; and laser-welding a chip LED between the positive electrode and intermediate elements. The present invention also provides a display in any shape fabricated by detachably and electrically interconnecting electrodes of multiple light-emitting units fabricated by these steps by means of connection blocks. The connection block may be one to which a covered conductor is connected, a pair of connection bridged by a covered conductor, a connection block three-dimensionally bent at an angle, an insulating connection block, or a L-shaped connection block. The connection blocks are used to connect an LED unit to a power supply line, interconnect LED units, and three-dimensionally combine LED units to fabricate a display.

### EFFECT OF THE INVENTION

According to the present invention, LED units can be flexibly combined linearly, two-dimensionally, or three-dimensionally in a detachable manner to fabricate a display without restriction on design.

Alternatively, LED units can be concentrated in a position or distributed.

Furthermore, the present invention provides flexibility in electric-circuit-theoretical coupling between LEDs. They can be connected in parallel, series, series-parallel, and parallel-series.

The LED units also have flexibility in installation conditions. They can be fixed to a substrate made of cork or plastic, which is an insulator, with pins, bolts, or sticks.

In summary, according to the present invention, LED units can be detachably combined, an LED display having flexibility in assembly, disassembly, and reassembly and therefore an increased flexibility of designs and installation can be implemented. Furthermore, the LED units can be refabricated and recycled and is therefore economically advantageous.

### BRIEF DESCRIPTION OF THE DRAWINGS

FIG. 1 is a top view of an LED unit according to an embodiment of the present invention.

FIG. 2 is a cross-sectional view of an LED unit 15 according to an embodiment of the present invention.

FIG. 3 is a cross-sectional view of a negative electrode connector 4 of an LED unit 15 according to an embodiment of the present invention.

FIG. 4 relates to fabrication of a connection block 19 according to an embodiment of the present invention and is a top view of generally square repeating units after undergoing a process for forming at least two generally square repeating units of the same size.

FIG. 5 relates to fabrication of a connection block 19 according to an embodiment of the present invention and is a top view of the repeating units after undergoing a process for mechanically connecting the repeating units using an insulating resin 2.

FIG. 6 relates to fabrication of a connection block 19 according to an embodiment of the present invention and is a cross-sectional view of the connection block 19 after a process for joining central coupling sections 31 for manufacturing the connection block 19 according to the embodiment of the present invention.

FIG. 7 is a cross-sectional view of a connection block 19 according to an embodiment of the present invention.

FIG. 8 is a plan view of a connection block 19 according to an embodiment of the present invention at its half height.

FIG. 9 is a top view of a connection block 19 according to an embodiment of the present invention.

FIG. 10 is a cross-sectional view of a connection block 19 according to an embodiment of the present invention in which negative electrode connectors 4 are engaged.

FIG. 11 is a plan view of a connection block 19 according to an embodiment of the present invention at its half height in which the negative electrode connectors 4 are engaged.

FIG. 12 is a cross-sectional view of a line-equipped connection block 20 according to an embodiment of the present invention.

FIG. 13 is a cross-sectional view of an L-shaped connection block 22 according to an embodiment of the present invention.

FIG. 14 is a plan view of a semi-connection block 25 according to an embodiment of the present invention at its half height.

FIG. 15 is a cross-sectional view of a semi-connection block 25 according to an embodiment of the present invention.

FIG. 16 is a cross-sectional view of an insulating resin connection block 26 according to an embodiment of the present invention.

FIG. 17 is a top view of a T-shaped light-emitting display in a first example of the present invention.

FIG. 18 is a top view for illustrating a process step S1 for fabricating a pair of line-equipped connection blocks in the first example of the present invention.

FIG. 19 is a top view for illustrating a process step S2 for fabricating a pair of line-equipped connection blocks in the first example of the present invention.

FIG. 20 is a side view for illustrating a process step S3 for fabricating a pair of line-equipped connection blocks in the first example of the present invention.

FIG. 21 is a cross-sectional view of a mirror-symmetric L-shaped light-emitting display in a second example of the present invention.

FIG. 22 is a top view of a mirror-symmetric L-shaped display rotated counterclockwise to an angle of 90 degrees according to a third example of the present invention.

FIG. 23 is a top view of a series-connected light-emitting display according to a fourth example of the present invention.

### DESCRIPTION OF SYMBOLS

1 Negative electrode conductor
2 Insulating resin
3 Chip-type resistor
4 Negative electrode connector
5 Hole
6 Punched hole (opening)
7 Intermediate conductor
8 Chip LED
9 Positive electrode conductor
10 Positive electrode connector
11 Anode
12 Cathode
13 Electrode
14 Electrode
15 LED unit
15a LED unit
15b LED unit
15c LED unit
15d LED unit
15e LED unit
16 Electrode
17 Cavity
18 Hole
19 Connection block
19a Connection block
19b Connection block
19c Connection block
19d Connection block
19e Connection block
19f Connection block
20a Line-equipped positive connection block
20b Line-equipped negative connection block
21 Covered conductor
22 L-shaped connection block
23 Negative power supply line
24 Positive power supply line
25 Semi-connection block
26 Insulating resin connection block
27 Line-equipped connection block pair
28 Generally T-shaped light-emitting display
29 Conductor
30 Projection
31 Central coupling section
32 Insulating resin plate

### BEST MODE FOR CARRYING OUT THE INVENTION

While embodiments of the present invention will be described below, the present invention is not limited to the embodiments.

According to the present invention, multiple LED units of various colors such as blue, red, yellow, white, and pink in a predetermined color arrangement are preferably provided beforehand in order to increase the flexibility of design.

Before LED modules are connected, resin of connecting blocks is warmed with a dryer to soften to such a degree that the resin is slightly moved by a slight push by the tips of tweezers so that the connection blocks can be easily connected. However, it is inadvisable to excessively warm the resin of the connecting blocks with a dryer to such a degree that the marks of the tips of tweezers are left after the resin is slightly pushed by the tips of the tweezers.

In an example of the present invention, the board on which a display is fabricated is a plywood board 1,820 mm long, 910 mm wide, and 3 mm thick with pushpins with plastic handle. LED units may be attached using double-sided or single-sided adhesive tapes.

Embodiments of the present invention will be described below with reference to the accompanying drawings.

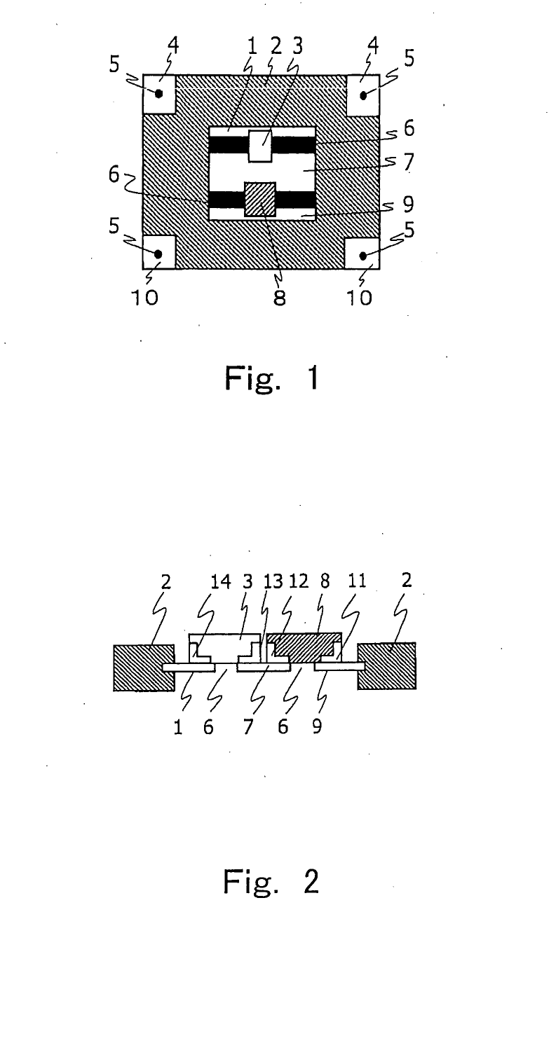

FIG. 1 is a top view of an LED unit, which is an embodiment of the present invention, fabricated as follows. A 30-mm long, 30-mm wide, 0.5-mm thick aluminum positive electrode conductor 9, a 30-mm long, 30-mm wide, 0.5-mm thick aluminum intermediate conductor 7, a 30-mm long, 30-mm wide, 0.5-mm thick aluminum negative electrode conductor 1 are placed 0.8 mm apart. An insulating resin 2 mechanically interconnects the positive electrode conductor 9, intermediate conductor 7, and negative electrode conductor 1. A chip LED 8, which is an orange SML-311DT chip LED (1608) from ROHM Co., is used. The anode 11 of the chip LED 8 is laser-welded to the positive electrode conductor 9. The cathode 12 of the chip LED 8 is laser-welded to the intermediate conductor 7. A 1608 chip resistor from ROHM Co. is used as a chip resistor 3. An electrode 13 of the chip resistor 3 is laser-welded to the intermediate conductor 7 and another electrode 14 of the chip resistor 3 is laser-welded to the negative electrode conductor 1 to form an LED unit 15. Referring again to FIG. 1, negative electrode connectors 4 are provided at the top corners of the LED unit 15, which is used for connecting the LED unit 15 with another LED unit through a connection block 19 to fabricate a combined light emitter array. Each of negative electrode connectors 4 has a through hole 5 that exposes both surfaces of each end of the negative electrode conductor 1 of the LED unit 15 in the insulating resin, exposes both surfaces of each end of the positive electrode conductor 9 in the insulating resin and holds an electrode of a connection block 19. Referring again to FIG. 1, positive electrode connectors 10 are provided at the bottom corners of the LED unit 15, which are used for connecting the LED unit 15 with another LED unit through a connection block 19 to form the combined light emitter array. Each of the positive electrode connectors 10 has a through hole 5 that exposes both surfaces of each end of the positive electrode conductor 9 of the LED unit 15 in the insulating resin and is used for latching an electrode of the connection block 19.

FIG. 2 is a cross-sectional view of the LED unit 15 according to the embodiment of the present invention, taken along a line perpendicular to the positive electrode conductor 9 of the LED unit 15 and passing through the center of the LED unit 15. Referring to FIG. 2, the negative electrode conductor 1 held by an insulating resin 2 is placed in parallel with an intermediate conductor 7 separated and electrically insulated from the negative electrode conductor 1 by a punched hole (opening) 6 and the intermediate conductor 7 is placed in parallel with the positive electrode conductor 9 spaced and electrically insulated from the intermediate conductor. The positive electrode conductor 9 is held by the insulating resin 2, and the negative electrode conductor 1, the intermediate conductor 7, and the positive electrode conductor 9 are positioned substantially on the same plane to form the substrate of the LED unit 15. On the substrate, the anode 11 of the chip LED 8 is joined with the positive electrode conductor 9, the cathode 12 of the chip LED 8 is joined with the intermediate conductor 7, an electrode 13 of the chip resistor is joined with the intermediate conductor 7, and another electrode 14 of the chip resistor is joined with the negative electrode conductor 1.

FIG. 3 is a cross-sectional view of the LED unit 15 according to the embodiment of the present invention, taken along a line passing through the center of the hole 5 punched for latching an electrode of a connection block 19 of the negative electrode connector 4 of the LED unit 15 and parallel with the cross-section shown in FIG. 2. It can be seen from FIG. 3 that a predetermined region of both surfaces of the negative electrode connector 4 having the through hole 5 punched for latching the electrode of the connection block 19 is exposed from the insulating resin 2.

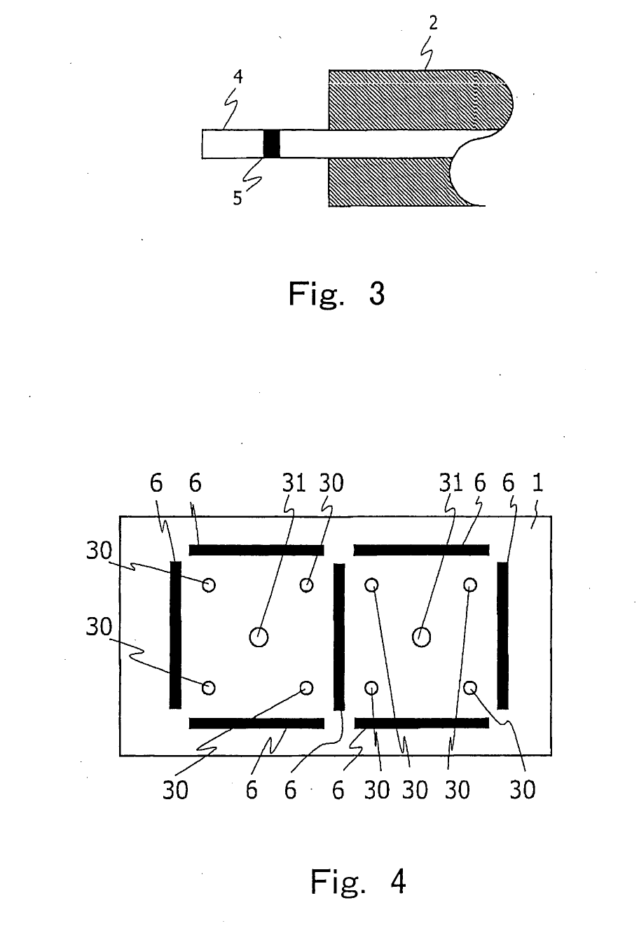

FIG. 4, which relates to fabrication of the connection block according to claim 6, is a top view of repeating units formed by a process for forming at least two generally square repeating units of the same size. Two generally square units are disposed side by side, each having outside four generally rectangular punched holes 6 having a width of 1/32 the side of the generally square shape and a length equal to or less than 30/32 the side of the generally square shape. Provided at the center of the generally square shape is a central coupling section 31, which is a projection having a diameter of 2/32 the side of the generally square shape and a height twice the thickness of a generally flat metallic conductor set forth in claim 2. Four projections 30 having a diameter of 1/32 the side of the generally square shape and a height approximately equal to the thickness of the generally flat metallic conductor set forth in claim 2 are provided at the positions 9/32 the side of the generally square shape distant from the center of the generally square shape, diagonally opposite each other.

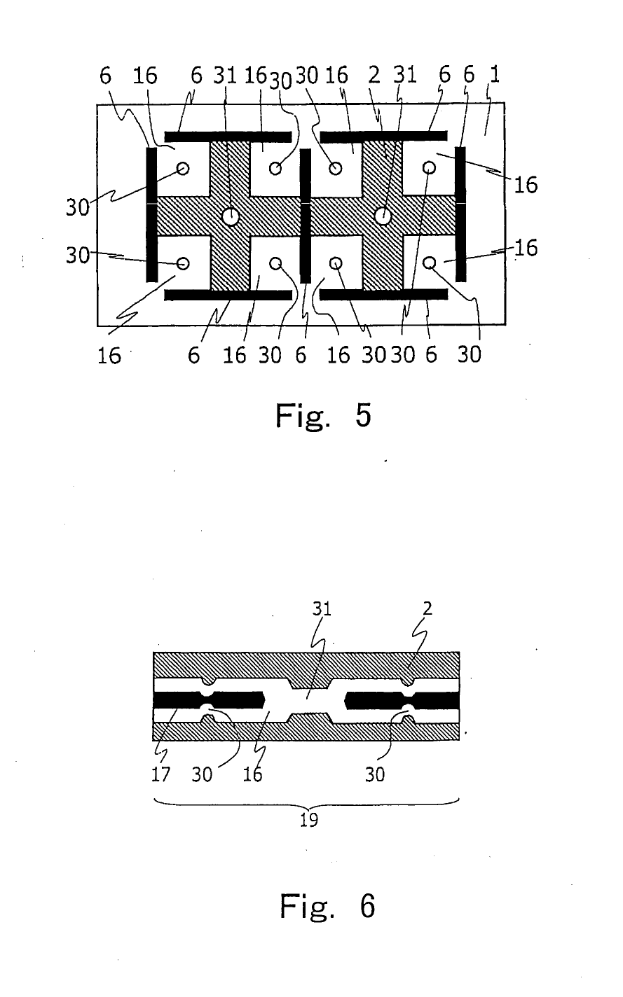

FIG. 5, which relates to fabrication of the connection block according to claim 6, is a top view of the repeating units after a process for mechanically interconnecting predetermined regions of the repeating units with an insulating resin 2 set forth in claim 2. It can be seen from FIG. 5 that the repeating units, except the central coupling section 31 and electrodes 16 inside the generally square section, are covered with the insulating resin 2 and the projection 30 is provided at about the center of each electrode 16.

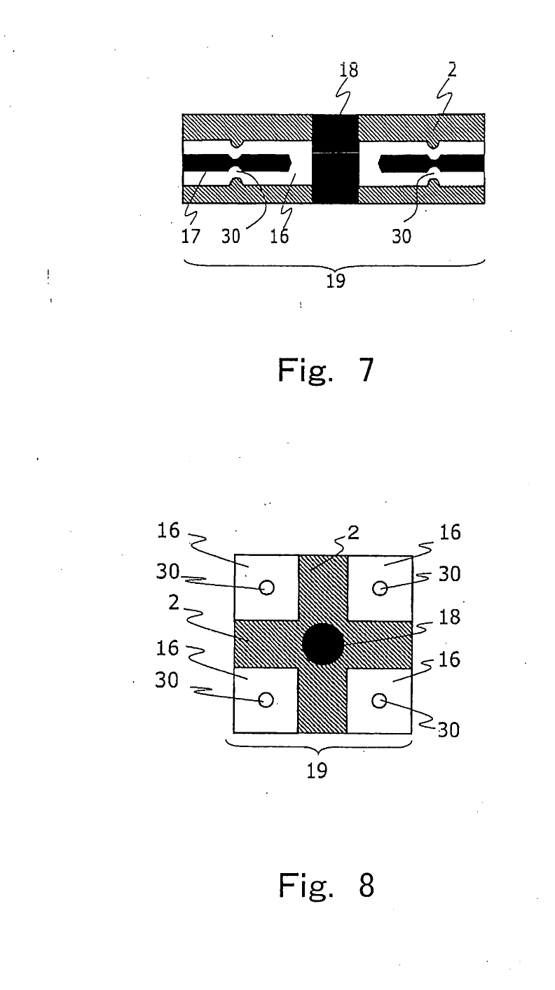

FIG. 6, which relates to fabrication of the connection block according to claim 6, is a cross-sectional view of the connection block 19, taken along a line passing through the center of the connection block 19 and parallel with one side of the connection block 19, after the step of cutting at predetermine position of the repeating units that is not mechanically connected using the insulating resin, the step of providing two cut repeating units, and the step of joining the central coupling sections 31 together in such a manner that the centers of the two cut repeating units are in line with each other and the surfaces in which the electrodes are exposed face each other. As shown, the two cut generally square repeating units of approximately the same size are joined together through the central coupling section 31 to form the connection block 19. After the subsequent step of forming a through hole 18 having a diameter of 1/32 the side of the generally square shape of the connection block 19 and smaller than the junction, the connection block 19 is completed as shown in FIG. 7.

FIG. 7 is a cross-sectional view of the connection block 19 according to the embodiment of the present invention, taken along the line passing through the center of the connection block 19 parallel with one side of the connection block 19. As shown in FIG. 7, provided in the insulating resin 2 are a cavity 17 for receiving a negative electrode connector 4 or a positive electrode conductor 9 of an LED unit 15 and an electrode 16 that detachably engages with the negative electrode connector 4 or the positive electrode conductor 9. A projection 30 that fits into a hole 5 for latching the negative electrode connector 4 or the positive electrode conductor 9 of the LED unit 15 is provided at about the center of the electrode 16 and a hole 18 used for fixing the connection block 19 with a pin, a stick, a bolt, or a nail is provided at the center of the connection block 19.

FIG. 8 is a plan view of the connection block 19 according to the embodiment of the present invention at its half height. As shown in FIG. 8, the outline of the connection block 19 is generally square; four regions are defined by the insulating resin 2 so as to expose the surface of four generally square electrodes 16 starting from the vertexes of the connection block 19 and having an approximately identical size. As shown, a projection 30 that fits into a hole 5 for latching a negative electrode connector 4 or a positive electrode conductor 9 of an LED unit 15 is provided at about the center of each of the four generally square electrodes 16 and a hole 18 used for fixing the connection block 19 with a pin, a stick, a bolt, or a nail is provided at about the center of the connection block 19.

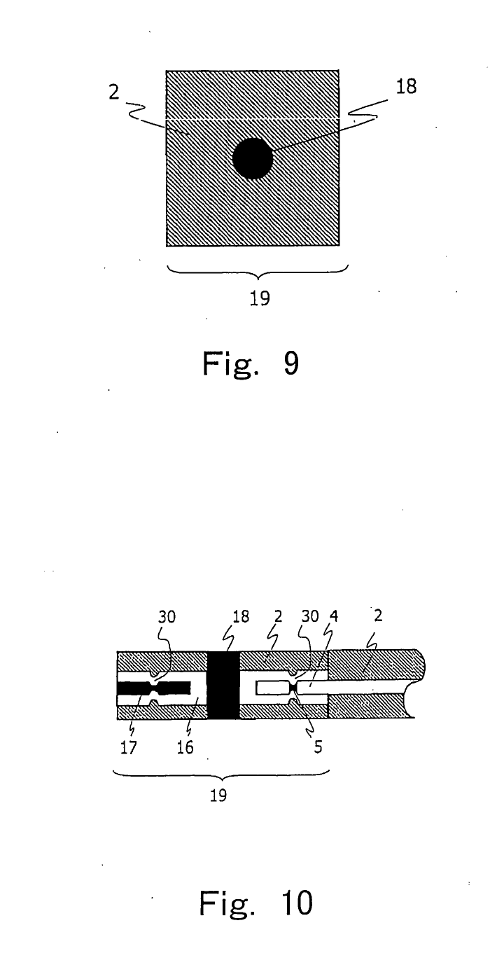

FIG. 9 is a top view of the connection block 19 according to the embodiment of the present invention. As shown, the generally square top surface of the connection block 19 is covered with the insulating resin 2 and the hole 18 used for fixing the connection block 19 with a pin, a stick, a bolt, or a nail is provided at about the center of the connection block 19.

FIG. 10 shows the connection block 19 according to the embodiment of the present invention, with which a negative electrode connector 4 is engaged. FIG. 10 is across-sectional view taken along a line passing through the center of the negative electrode connector 4 and the center of the hole 18 used for fixing the connection block 19 with a pin, a stick, a bolt, or a nail. As shown in FIG. 10, the cavity 17 defined by the electrode 16 in the insulating resin 2 of the connection block 19 receives the negative electrode connector 4 of an LED unit 15, the hole 5 formed in about the center of the exposed negative electrode connector 4 coincides with and well latches the projection 30 formed at about the center of the electrode 16 of the connection block 19, and thus the electrode 16 is properly joined with the negative electrode connector 4 in detachable engagement.

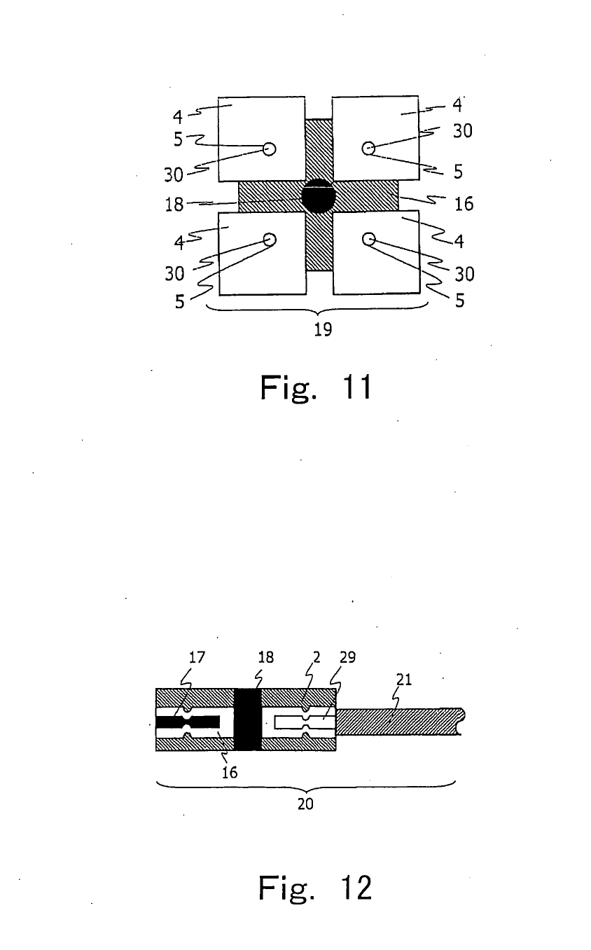

FIG. 11 shows the connection block 19 according to the embodiment of the present invention, with which the negative electrode connector 4 is engaged. FIG. 11 is a plan view taken along a line passing through the center of the thickness of the negative electrode connector 4 and parallel with the negative electrode connector 4. As shown, the hole 18 used for fixing the connection block 19 with a pin, a stick, a bolt, or a nail and the hole 5 formed in about the center of the exposed negative electrode connector 4 coincide with and well latch the projection 30 formed at about the center of the electrode 16 of the connection block 19, and thus up to four negative electrode connectors 4 of the LED 15 in a detachable engagement state are properly engaged.

FIG. 12 shows a line-equipped connection block 20 formed by connecting the conductor 29 of a covered conductor 21 to one of the four electrodes 16 of a connection block 19 according to an embodiment of the present invention so that up to three negative electrode connectors 4 can be engaged. FIG. 12 is a cross-sectional view taken along a line between the center of the negative electrode connector 4 and the hole 18 used for fixing the connection block 19 with a pin, a stick, a bolt, or a nail. As shown in FIG. 12, the hole 18 used for fixing the negative electrode connector 4 and the connection block 19 with a pin, a stick, a bolt, or a nail and the conductor 29 of the covered conductor 21 are properly engaged with the electrode 16 of the connection block 19.

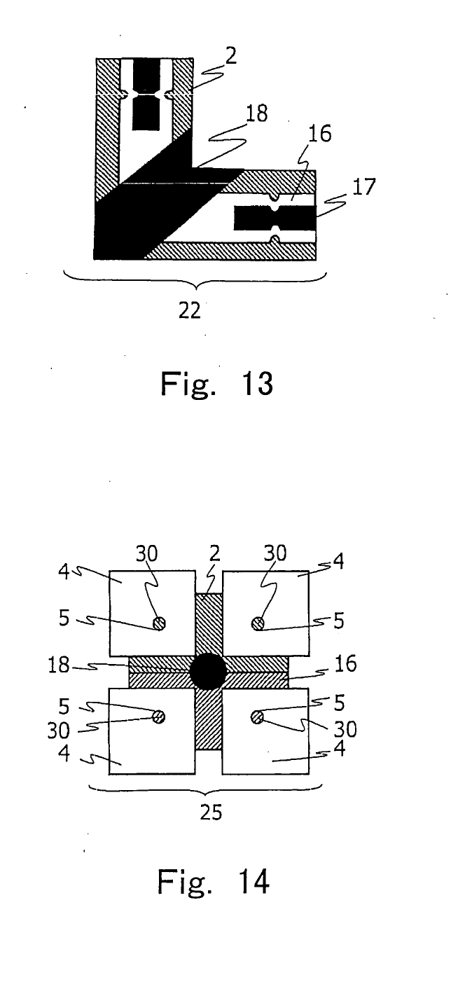

FIG. 13 is a cross-sectional view of an L-shaped connection block 22 in which an electrode 16 of the connection block 19 is bent at an angle of 90 degrees into an L shape according to an embodiment of the present invention. As shown, the connection block 19 three-dimensionally bends at an angle of 90 degrees along a line passing through the center of the hole 18 used for fixing the connection block 19 with a pin, a stick, a bolt, or a nail and dividing the connection block 19 into two and the cross-section is L-shaped.

FIG. 14 is a plan view of a semi-connection block 25 taken along a line passing through the center of the thickness of a negative electrode connector 4 in parallel with the negative electrode connector 4. Adjacent two of the four electrodes 16 of a connection block 19 according to the embodiment of the present invention are eliminated and an insulating resin 2 is formed instead so that up to four LED unit 15 can be engaged with the connection block at a time, of which adjacent two are mechanically and electrically engaged and the other adjacent two can only mechanically be engaged, thus forming the semi-connection block 25. As shown, a hole 18 used for fixing the connection block 19 with a pin, a stick, a bolt, or a nail and a hole 5 formed in about the center of the exposed negative electrode connector 4 coincide with and properly latch a projection 30 formed at about the center of an electrode 16 of the connection block 19 and thus up to four negative electrode connectors 4 of an LED unit 15 in a detachable engagement state are engaged.

FIG. 15 is a cross-sectional view of the semi-connection block 25 according to the embodiment of the present invention, taken along a line passing through the center of the semi-connection block 25 in parallel with a side of the semi-connection block 25. Shown in FIG. 15 are a cavity 17 formed in the insulating resin 2 for receiving a negative electrode connector 4 or a positive electrode conductor 9 of an LED unit 15, one of substitutes formed from the insulating resin 2 in place of the eliminated adjacent two of the four electrodes 16 of the connection block 19, an electrode 16 which detachably engages with the negative electrode connector 4 or the positive electrode conductor 9, and a hole 18 used for fixing the connection block 19 with a pin, a stick, a bolt, or a nail.

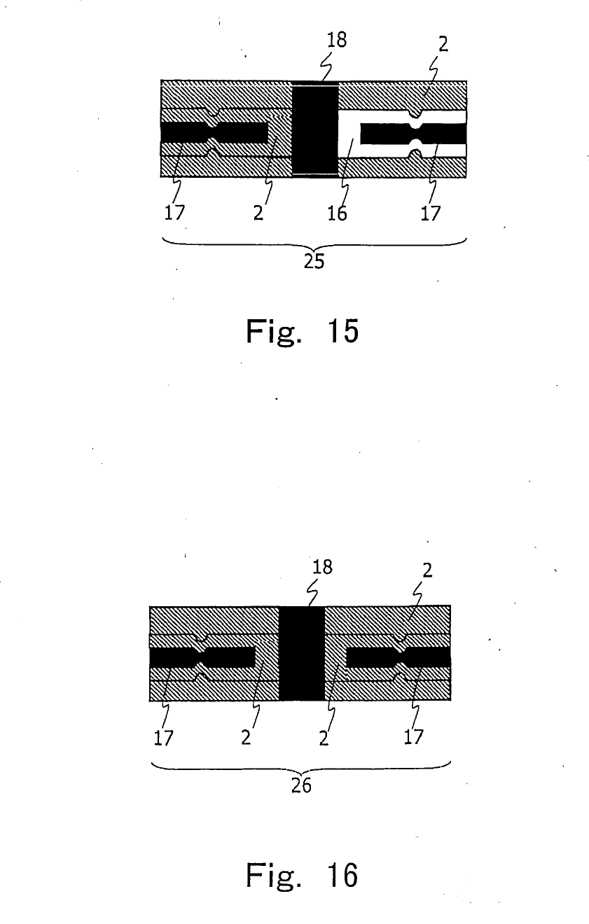

FIG. 16 is a cross-sectional view of an insulting resin connection block 26 according to an embodiment of the present invention, taken along a line passing through the center of the insulating resin connection block 26 parallel with one side of the insulating resin connection block 26. Shown in FIG. 16 are cavity 17 formed in an insulating resin 2 for receiving a negative electrode connector 4 or positive electrode conductor 9 of an LED unit 15, substitutes formed from the insulating resin 2 in place of the four electrodes eliminated from the connection block 19, a hole 18 used for fixing the connection block 19 with a pin, stick, bolt, or nail.

### EXAMPLES

The present invention will be described more specifically with respect to examples.

### First Example

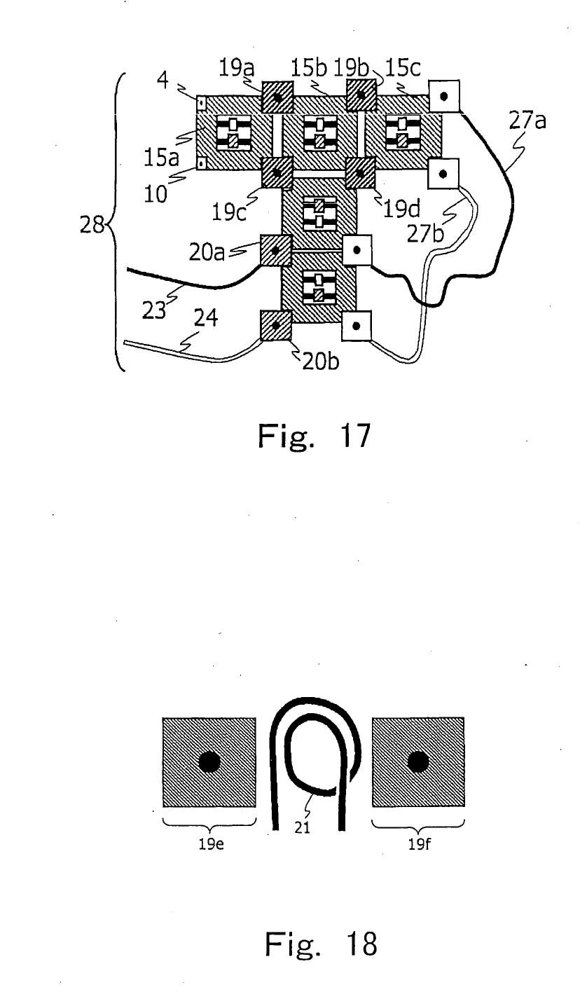

FIG. 17 is a top view of an example of a T-shaped light-emitting display 28 fabricated by engaging five LED units 15 with each other through a connection block 19.

Referring to FIGS. 18, 19, and 20, first a process will be described for forming a pair of line-equipped connection blocks 27 interconnected through a covered conductor 21 of a predetermined length used for interconnecting electrode connectors of an identical type of given LED units 15 spaced apart.

FIG. 18 shows the step (S1) of providing a connection blocks 19e and 19f and a covered conductor 21 with a predetermined length.

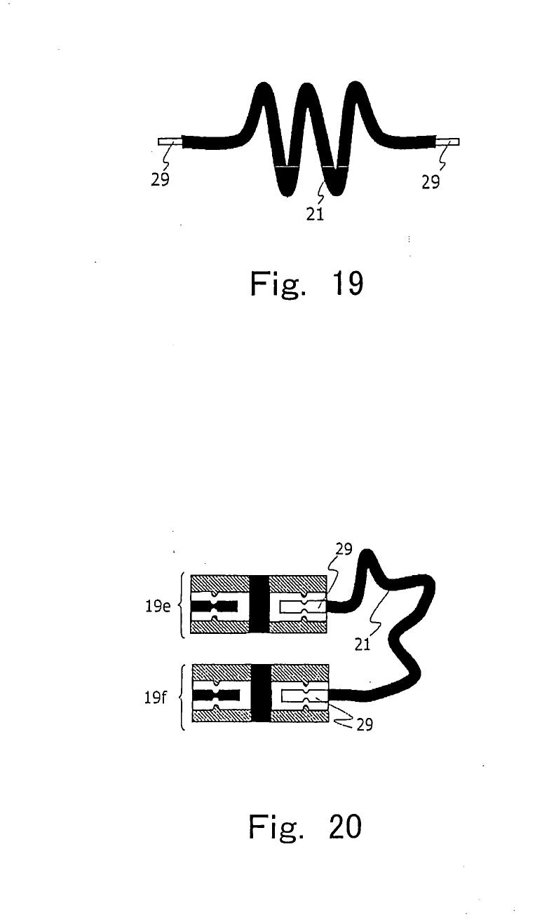

FIG. 19 shows the step (S2) of bringing the ends of the covered conductor 21 substantially in line with each other, then removing portions of the cover of the covered conductor 21 to expose a conductor 29.

FIG. 20 shows the step (S3) of joining the ends of the conductor 29 of the covered conductor 21 to an electrode 16 of the connection block 19e and an electrode 16 of the connection block 19f using solder or an electrically conductive adhesive to complete a pair of line-equipped connection blocks 27. FIG. 17 shows a cross-section of the connection blocks 19e and 19f and a side view of the covered conductor 21 for showing that both ends of the conductor 29 of the covered conductor 21 are properly joined with the electrodes of the connection blocks 19e and 19f. A pair of line-equipped connection blocks 27a and 27b connected through a covered conductor 21 with a predetermined length are used in this example.

Second, LED units 15a, 15b, and 15c are provided and arranged in line in this order from left to right in such a manner that negative electrode connectors 4 of LED units 15a, 15b, and 15c are positioned at the top as shown in FIG. 17. The negative electrode connectors 4 of LED units 15a and 15b are interconnected through connection block 19a, the negative electrode connectors 4 of LED units 15b and 15c are interconnected through connection block 19b, the positive electrodes 10 of LED units 15a and 15b are interconnected through connection block 19c, and the positive electrode connectors 10 of LED units 15b and 15c are interconnected through connection block 19d.

Third, an LED unit 15d is provided and placed in such a manner that the negative electrode connector 4 of LED unit 15d is at the bottom as shown in FIG. 17. LED unit 15d is engaged with connection blocks 19c and 19d connected with LED unit 15b in correct polarity.

Fourth, LED unit 15e is placed below LED unit 15d in such a manner that electrodes with the same polarity face each other and the LED units form T-shape as shown in FIG. 17. The negative electrode connectors 4 of the adjacent LED units 15 are interconnected through a connection block 19, the positive electrode connectors 10 of the adjacent LED units 15 are interconnected through a connection block 19, and the LED unit 15 is engaged in correct polarity with the connection block 19 coupled to the middle one of the three LED units 15 interconnected in line at the second step, thus completing the arrangement of the LED units 15 in generally T-shape.

Last, a positive line-equipped connection block 20a coupled to a positive power supply line 24 is connected to an appropriate positive electrode connector 10 of the generally T-shaped light-emitting display 28 and a negative line-equipped connection block 20b coupled to a negative power supply line 23 is connected to an appropriate negative electrode connector 4 of the generally T-shaped light-emitting display 28 as shown in FIG. 17. A direct-current voltage of 4.5 volts was applied between the positive power supply line 24 and the negative power supply line 23 of the generally T-shaped light emitting display 28 and emission of light was observed.

### Second Example

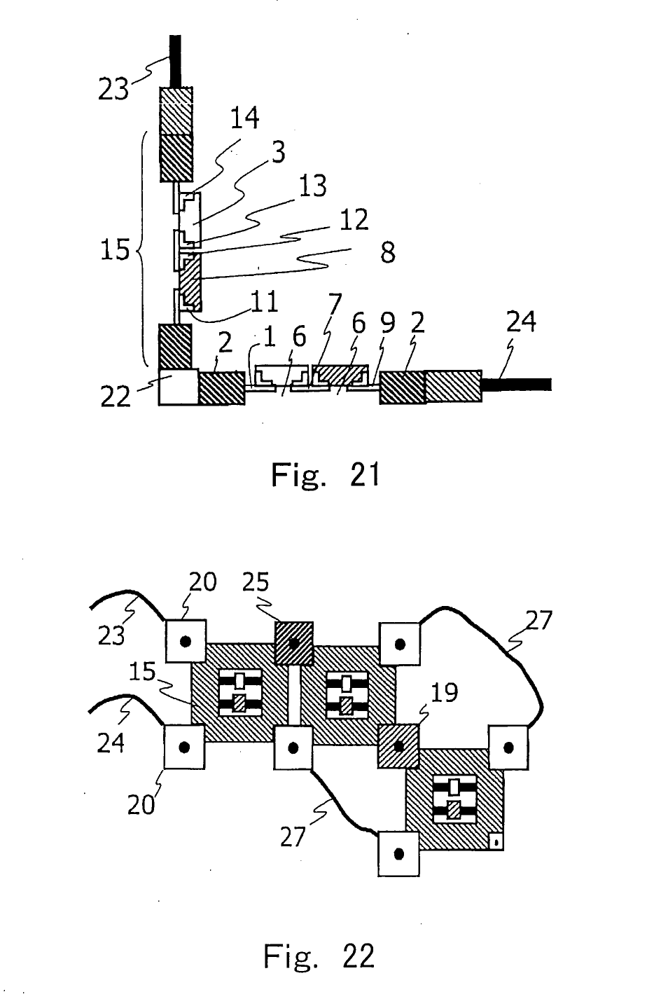

FIG. 21 shows an example of an L-shaped light-emitting display arranged at an angle of 90 degrees using an L-shaped connection block 22. FIG. 21 is a cross-sectional view taken along a line passing through the center of an LED 8 and perpendicular to an intermediate conductor 7. LED modules 15 are electrically connected in series. The L-shaped light-emitting display in the second example is only illustrative of the present invention according to claim 11.

A line-equipped connection block 20 coupled to a positive power supply line 24 is connected to an appropriate positive electrode connector of the L-shaped light-emitting display, a line-equipped connection block 20 coupled to the negative power supply line 23 is connected to an appropriate negative electrode connector of the L-shaped light-emitting display. A direct-current voltage of 4.5 volts was applied between the positive power supply line 24 and the negative power supply line 23 of the L-shaped light-emitting display and light emission was observed.

### Third Example

FIG. 22 is a top view of an exemplary mirror-symmetric L-shaped display rotated counterclockwise by 90 degrees fabricated using a semi-connection block 25, a connection-block 19, and two pairs of line-equipped connection blocks 27.

In the mirror-symmetric L-shaped display rotated counterclockwise by 90 degrees, a line-equipped connection block 20 coupled to a positive power supply line 24 is connected to an appropriate positive electrode connector 10 of the mirror-symmetric L-shaped light-emitting display and a line-equipped connection block 20 coupled to a negative power supply line 23 is connected to an appropriate negative electrode connector of the mirror-symmetric L-shaped light-emitting display. A direct current voltage of 4.5 volts was applied between the positive power supply line 24 and the negative power supply line 23 of the mirror-symmetric L-shaped light-emitting display and emission of light was observed.

### Fourth Example

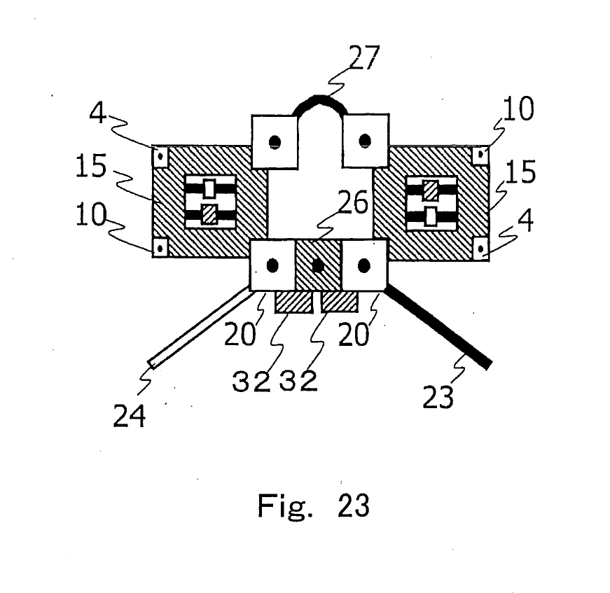

FIG. 23 is a top view of a light-emitting display fabricated by interconnecting two LED units 15 spaced apart in line using an insulating resin connection block 26, a pair of line-equipped connection blocks 27, and two insulating resin panels having a latching hole with the same thickness and specifications of those of a positive or negative electrode connector of the LED units 15. The exemplary light-emitting display consisting of series-connected LED units 15 in the fourth example is only illustrative of the present invention according to claims 12 and 13.

The light-emitting display consisting of series-connected LED units 15 is fabricated by connecting a line-equipped connection block 20 coupled to a negative power supply line 23 with one side of a quadrangle, generally square insulating resin connection block 26 in such a manner that their sides touch each other, a line-equipped connection block 20 coupled to a positive power supply line 24 is connected onto the 180-degree opposite side of the quadrangular, generally square insulating resin connection block 26 in such a manner that their sides touch each other, and a negative electrode connector 4 of one of the LED units 15 is connected to a positive electrode connector 10 of the other LED unit 15 by a pair of line-equipped connection block 27. To fabricate the series-connected light-emitting display, the LED unit 15 connected to the line-equipped connection block 20 coupled to the positive power supply line 24 is rotated about the center of the LED unit plane by 180 degrees with respect to the LED unit 15 connected to the line-equipped connection block 20 coupled to the negative power supply line 23 such that the positive electrode conductors 9 of the LED units 15 is positioned at an angle of 180 degrees with respect to each other. A direct-current voltage of 4.5 volts was applied between the positive power supply line 24 and the negative power supply line 23 of the series-coupled light-emitting display and emission of light was observed.

1-13. (canceled)

14. A light-emitting display fabricating method for fabricating a display in any shape by using a plurality of LED units, the method comprising detachably and electrically connecting the plurality of LED units by using a plurality of connection blocks having engaging means for detachably interconnecting the plurality of LED units to fabricate a display.

15. A detachable LED unit fabricating method for fabricating an LED unit used for fabricating a light-emitting display in any shape by using a plurality of LED units having engaging means for detachably interconnecting LED units, the method comprising:
placing a positive electrode element formed by a generally flat metallic conductor, a relay element formed by a generally flat metallic conductor, and a negative electrode element formed by a generally flat metallic conductor in the order of the positive electrode element, the relay element, and the negative electrode element in parallel with each other and evenly spaced apart from each other;
mechanically interconnecting the positive electrode element, the relay element, and the negative electrode element by using an insulating resin;
exposing both surfaces of a predetermined region of each end of the metallic conductors except for the relay element as an extension electrode element;
laser-welding a chip LED between the positive electrode and the relay element;
laser-welding a chip resistor between the relay element and the negative electrode element; and
providing a hole and a projection in predetermined positions in the LED unit as engaging means.

16. A detachable LED unit being a light-emitting unit disposed on a connection block having engaging means capable of detachably interconnecting LED units, the detachable LED unit comprising three generally flat metallic conductors spaced apart from each other and mechanically interconnected using an insulating resin, the three spaced-apart metallic conductors forming a positive electrode element, a negative electrode element, and a relay element, and any of the metallic conductor that forms the positive electrode element, the metallic conductor that forms the negative electrode element, and the metallic conductor that forms the relay element being flexible.

17. A detachable LED unit, wherein both surfaces of a predetermined region of each end of the positive electrode element and/or negative electrode element are exposed as an extension electrode element, and a hole used for engaging with an interconnection block is formed in a predetermined position in the surface of the extension electrode element.

18. A structure of a connection block having a detachable LED unit according to claim 16, wherein:
a generally flat metallic conductor is shaped to form at least two generally square repeating units having a predetermined depression and projection and a predetermined identical size;
predetermined regions of the repeating units are mechanically interconnected by using an insulating resin;
the repeating units are cut at a predetermined position of the repeating units that is not mechanically connected using the insulating resin;
two cut repeating units are provided;
surfaces where the centers of the two cut repeating units are in line with each other and electrodes are exposed are opposed to each other to join central coupling elements together;
a through hole is formed at a center of a generally square shape of a top of the joined surfaces, the hole having a diameter of 1/32 the side of the generally square shape and smaller than the joined area;
an outline of each of the repeating units is generally square; each of the repeating units comprises:
a central coupling section formed at the center of the generally square shape, the central coupling section being a projection that projects upward and has a trapezoidal cross-section, the diameter of the area at the base of the trapezoidal cross-section being 2/32 the side of the generally square shape, the height of the projection being twice the thickness of the generally flat metal conductor;
a projection provided at a position 9/32 the side of the generally square shape distant from the center of the generally square shape, on a diagonal line passing through the center of the generally square shape, the projection having a diameter of 1/32 the side of the generally square shape and a height approximately equal to the thickness of the generally flat metallic conductor; and
a generally rectangular punched hole provided outside and near each side of the generally square shape in order to space the repeating unit apart from another repeating unit, the hole having a width of 1/32 the side of the generally square shape and a length less than or equal to 30/32 the side of the generally square shape, wherein:
the predetermined regions of the repeating unit mechanically connected by using the insulating resin are a region inside the generally square shape on the side opposite to the side on which the projection is provided at the center of the generally square shape that projects upward and has a trapezoidal cross-section and a diameter, at the base of the trapezoidal cross-section, of 2/32 the side of the generally square shape, and a region inside the generally square shape on the side on which the projection is provided at the center of the generally square repeating unit that projects upward and has a trapezoidal cross-section and a diameter, at the base of the trapezoidal cross-section, of 2/32 the side of the generally square shape, the region excluding the projection, passing through the center of the generally square shape, being parallel with each side of the generally square shape, and having a width of 4/32 the side of the generally square shape; and
the thickness of the insulating resin in the predetermined regions of the repeating unit filled with the insulating resin does not exceed the thickness of the generally flat metallic conductor.

19. A structure of a connection block having a detachable LED unit according to claim 17, wherein:
a generally flat metallic conductor is shaped to form at least two generally square repeating units having a predetermined depression and projection and a predetermined identical size;
predetermined regions of the repeating units are mechanically interconnected by using an insulating resin;
the repeating units are cut at a predetermined position of the repeating units that is not mechanically connected using the insulating resin;
two cut repeating units are provided;
surfaces where the centers of the two cut repeating units are in line with each other and electrodes are exposed are opposed to each other to join central coupling elements together;
a through hole is formed at a center of a generally square shape of a top of the joined surfaces, the hole having a diameter of 1/32 the side of the generally square shape and smaller than the joined area;
an outline of each of the repeating units is generally square; each of the repeating units comprises:
a central coupling section formed at the center of the generally square shape, the central coupling section being a projection that projects upward and has a trapezoidal cross-section, the diameter of the area at the base of the trapezoidal cross-section being 2/32 the side of the generally square shape, the height of the projection being twice the thickness of the generally flat metal conductor;
a projection provided at a position 9/32 the side of the generally square shape distant from the center of the generally square shape, on a diagonal line passing through the center of the generally square shape, the projection having a diameter of 1/32 the side of the generally square shape and a height approximately equal to the thickness of the generally flat metallic conductor; and
a generally rectangular punched hole provided outside and near each side of the generally square shape in order to space the repeating unit apart from another repeating unit,
the hole having a width of 1/32 the side of the generally square shape and a length less than or equal to 30/32 the side of the generally square shape, wherein:
the predetermined regions of the repeating unit mechanically connected by using the insulating resin are a region inside the generally square shape on the side opposite to the side on which the projection is provided at the center of the generally square shape that projects upward and has a trapezoidal cross-section and a diameter, at the base of the trapezoidal cross-section, of 2/32 the side of the generally square shape, and a region inside the generally square shape on the side on which the projection is provided at the center of the generally square repeating unit that projects upward and has a trapezoidal cross-section and a diameter, at the base of the trapezoidal cross-section, of 2/32 the side of the generally square shape, the region excluding the projection, passing through the center of the generally square shape, being parallel with each side of the generally square shape, and having a width of 4/32 the side of the generally square shape; and
the thickness of the insulating resin in the predetermined regions of the repeating unit filled with the insulating resin does not exceed the thickness of the generally flat metallic conductor.

20. The structure of the connection block according to claim 18, wherein:
both surfaces of a predetermined region of each end of a positive electrode element and/or a negative electrode element are exposed as an extension electrode and a hole is formed in a predetermined position in a surface of the extension electrode for engaging with a connection block used for interconnection; and
the connection block comprises a projection for engaging the predetermined depression and projection into a hole formed in an extension electrode of an LED unit and has, at each vertex of a generally square shape of the top surface, electrodes spaced apart from each other and facing each other so that the electrodes can engage with the extension electrode of the LED unit, and has a through hole smaller than the joined region; and
the LED unit is a detachable LED unit, in which both surfaces of a predetermined region of each end of the positive electrode element and/or negative electrode element are exposed as an extension electrode element, and a hole used for engaging with an interconnection block is formed in a predetermined position in the surface of the extension electrode element.

21. The structure of the connection block according to claim 19, wherein:
both surfaces of a predetermined region of each end of a positive electrode element and/or a negative electrode element are exposed as an extension electrode and a hole is formed in a predetermined position in a surface of the extension electrode for engaging with a connection block used for interconnection;
the connection block comprises a projection for engaging the predetermined depression and projection into a hole formed in an extension electrode of an LED unit and has, at each vertex of a generally square shape of the top surface, electrodes spaced apart from each other and facing each other so that the electrodes can engage with the extension electrode of the LED unit, and has a through hole smaller than the joined region; and
the LED unit is a detachable LED unit, in which both surfaces of a predetermined region of each end of the positive electrode element and/or negative electrode element are exposed as an extension electrode element, and a hole used for engaging with an interconnection block is formed in a predetermined position in the surface of the extension electrode element.

22. The structure of the connection block according to claim 20, wherein a conductor of a covered conductor is electrically connected to at least one of four electrodes disposed at the vertexes of the generally square shape of the top surface of the connection block.

23. The structure of the connection block according to claim 21, wherein a conductor of a covered conductor is electrically connected to at least one of four electrodes disposed at the vertexes of the generally square shape of the top surface of the connection block.

24. The structure of the connection block according to claim 22, wherein a conductor at an end of a covered conductor of the connection block equipped with the covered conductor is electrically connected to at least one of four electrodes disposed at the vertexes of a generally square shape of a connection block in such a manner that the covered conductor bridges the two connection blocks.

25. The structure of the connection block according to claim 23, wherein a conductor at an end of a covered conductor of the connection block equipped with the covered conductor is electrically connected to at least one of four electrodes disposed at the vertexes of a generally square shape of a connection block in such a manner that the covered conductor bridges the two connection blocks.

26. The structure of the connection block according to claim 20, wherein the electrode of the connection block electrically interconnects adjacent two of the LED units in a detachable manner and insulatingly interconnects the other two LED units in a detachable manner.

27. The structure of the connection block according to claim 21, wherein the electrode of the connection block electrically interconnects adjacent two of the LED units in a detachable manner and insulatingly interconnects the other two LED units in a detachable manner.

28. The structure of the connection block according to claim 18, wherein the connection block is pre-bent along a straight line passing through the center of the connection block in parallel with a side of the connection block so that two adjacent LED units can be three-dimensionally and electrically interconnected at an angle in a detachable manner.

29. The structure of the connection block according to claim 19, wherein the connection block is pre-bent along a straight line passing through the center of the connection block in parallel with a side of the connection block so that two, adjacent LED units can be three-dimensionally and, electrically interconnected at an angle in a detachable manner.

30. The structure of the connection block according to claim 18, wherein the connection block has the geometry of a polygon and each side of the polygon touches a side of another connection block to form an assembly.

31. The structure of the connection block according to claim 19, wherein the connection block has the geometry of a polygon and each side of the polygon touches a side of another connection block to form an assembly.
